(19) United States
(12) Patent Application Publication
(10) Pub. No.: US 2021/0348841 A1
(43) Pub. Date: Nov. 11, 2021

(54) METHOD FOR OPERATING A RELIQUEFACTION SYSTEM

(71) Applicants: L'Air Liquide, Société Anonyme pour l'Etude et l'Exploitation des Procédés Georges Claude, Paris (FR); Air Liquide Advanced Technologies U.S. LLC, Houston, TX (US)

(72) Inventors: Pierre-Philippe GUERIF, Houston, TX (US); Gilles FLAVIEN, Grenoble (FR); Alain GUILLARD, Houston, TX (US); Vincent FOLLACA, Houston, TX (US)

(21) Appl. No.: 17/315,031

(22) Filed: May 7, 2021

Related U.S. Application Data
(60) Provisional application No. 63/021,856, filed on May 8, 2020.
(60) Provisional application No. 63/021,860, filed on May 8, 2020.
(60) Provisional application No. 63/021,898, filed on May 8, 2020.

(51) Int. Cl. F25J 1/02; F25J 1/00

(52) U.S. Cl. CPC F25J 1/0258; F25J 1/0072; F25J 2290/20; F25J 1/0262; F25J 1/0077

(57) ABSTRACT

A method for increasing the reliability and availability of a cryogenic fluid reliquefaction system is provided. Wherein the liquid cryogenic fluid is supplied to a cryogenic liquid user in the absence of a pump by elevating the storage height of the main cryogenic storage tank relative to the liquid cryogenic liquid user to a minimum predetermined height. Wherein the temperature of the liquid cryogenic fluid downstream of the sub-cooler is at least 1 degree Celsius above the freezing point of the cryogenic fluid at the internal pressure. The method also includes controlling the internal pressure of the main cryogenic tank by adjusting the recirculation flow to the, and maintaining the cold supply to the liquid cryogenic fluid user when the sub-cooling line is reduced or stopped by venting the vaporized cryogenic fluid.

### CROSS REFERENCE TO RELATED APPLICATIONS

This application claims the benefit of priority under 35 U.S.C. § 119 (a) and (b) to U.S. Provisional Patent Application Nos. 63/021,856, 63/021,860, and 63/021,898, all filed May 8, 2020, the entire contents of which are incorporated herein by reference.

### BACKGROUND

In some particular applications, a cryogenic liquid stream such as liquid nitrogen may be used for cooling purpose. In this case, the liquid nitrogen will usually, at least partially vaporize, and there will be a need to recondense this nitrogen vapor to avoid losses of nitrogen product and cold energy (refrigeration). A typical method used to recondense such a stream is to cool the gas and extract some enthalpy until the liquefaction is complete. The enthalpy extraction is typically performed via indirect thermal exchange with another fluid which will typically undergo some various steps of compression, cooling and pressure letdown in valves or/and turbines.

A typical alternate solution is to mix the gaseous stream with a sub-cooled liquid so that the direct thermal exchange between the gas and sub-cooled liquid will condense the gaseous stream. This mixing can typically be implemented in the vapor phase of a tank.

### SUMMARY

A method for increasing the reliability and availability of a cryogenic fluid reliquefaction system is provided. The method includes connecting a reliquefaction system to a liquid cryogenic fluid user which is then supplied a liquid cryogenic fluid, vaporizing the liquid cryogenic fluid within the liquid cryogenic fluid user, and venting the vaporized cryogenic fluid. Wherein the liquid cryogenic fluid is supplied to the cryogenic liquid user in the absence of a pump by elevating the storage height of the main cryogenic storage tank relative to the liquid cryogenic liquid user to a minimum predetermined height. Wherein a sub-cooler with an internal pressure is provided. Wherein the temperature of the liquid cryogenic fluid downstream of the sub-cooler is at least 1 degree Celsius above the freezing point of the cryogenic fluid at the internal pressure.

A method for controlling the pressure of a cryogenic fluid reliquefaction system connecting to a liquid cryogenic fluid user which is supplied a liquid cryogenic fluid that is vaporized and sent back to the main cryogenic tank to be recondensed against a sub-cooled liquid stream in a cooling loop is provided. The method includes providing a main cryogenic tank comprising an internal pressure, a sub-cooler comprising a recirculation stream flowrate, and a venting valve. The method includes controlling the internal pressure of the main cryogenic tank by adjusting the recirculation flow to the, and maintaining the cold supply to the liquid cryogenic fluid user when the sub-cooling line is reduced or stopped by venting the vaporized cryogenic fluid.

### BRIEF DESCRIPTION OF THE FIGURE

For a further understanding of the nature and objects for the present invention, reference should be made to the following detailed description, taken in conjunction with the accompanying drawings, in which like elements are given the same or analogous reference numbers and wherein:

FIG. 1 is a schematic representation of one embodiment of the present invention.

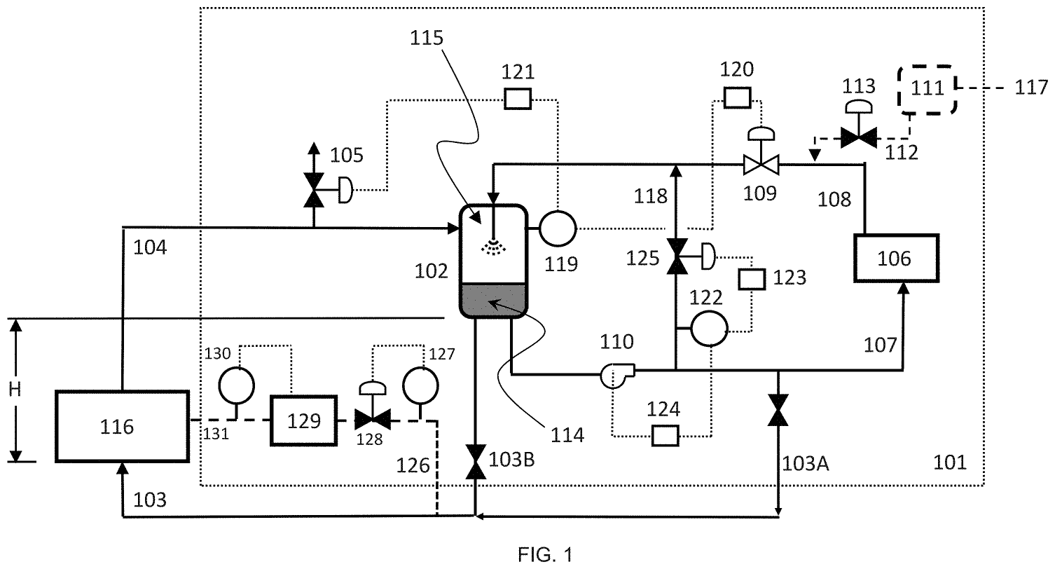

### ELEMENT NUMBERS

101=reliquefaction system
102=main cryogenic tank
103=liquid cryogenic fluid stream
104=vaporized cryogenic fluid stream
105=vent valve
106=sub-cooler
107=warm recirculation stream
108=sub-cooled recirculation stream
109=recirculation control valve
110=recirculation pump
111=liquid buffer tank
112=buffer tank transfer stream
113=buffer tank transfer control valve
114=liquid cryogenic fluid (in main cryogenic tank)
115=cryogenic fluid vapor (in main cryogenic tank)
116=liquid cryogenic fluid user
117=external liquid cryogenic fluid source
118=sub-cooler bypass line
119=first pressure transmitter (in main cryogenic tank)
120=first peripheral interface controller
121=second peripheral interface controller
122=second pressure transmitter (in sub-cooler bypass line)
123=third peripheral interface controller
124=fourth peripheral interface controller
125=bypass control valve

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time consuming but would nevertheless be a routine undertaking for those of ordinary skill in the art having the benefit of this disclosure.

The system below describes the use of liquid nitrogen, but one skilled in the art will recognize that any suitable cryogenic fluid may be used with the same concept (oxygen, methane, etc. . . . ) depending on the temperature level required for cooling the targeted system.

One embodiment of the present invention is schematically illustrated in the sole FIGURE. A reliquefaction system 101 includes a main cryogenic tank 102, a liquid nitrogen stream 103, a vaporized nitrogen stream 104, and a vent valve 105 fluidically attached to vaporized nitrogen stream 104. The reliquefaction system 101 also includes a sub-cooler 106, a warm recirculation stream 107, a sub-cooled recirculation stream 108, a recirculation control valve 109, and a recirculation pump 110. The reliquefaction system 101 also includes a liquid buffer tank 111, a buffer tank transfer stream 112, and a buffer tank transfer control valve 113. Liquid buffer tank 111 may be refilled as needed from an external liquid nitrogen source 117, such as a liquid nitrogen truck trailer (not shown).

Liquid nitrogen 114 is stored at saturated conditions (pressure P1) in main cryogenic Tank 102. Nitrogen vapor 115 will occupy the headspace of main cryogenic tank 102. During normal operations, a portion of liquid nitrogen 114 is extracted from main cryogenic tank 102 and sent to a liquid nitrogen user 116. Liquid nitrogen user 116 will utilize liquid nitrogen stream 103 for internal refrigeration purposes. Liquid nitrogen stream 103 will thus be vaporized and vaporized nitrogen stream 104 will be recirculated to main cryogenic Tank 102.

Simultaneously, a portion of liquid nitrogen 114 is extracted from main cryogenic tank 102 as warm recirculation stream 107 and sent to recirculation pump 110. The pressurized liquid nitrogen then enters sub-cooler 106. Sub-cooler 106 will cool the liquid nitrogen by at least several degrees Celsius. This may be accomplished by any frigorific unit known in the art that can reach the required temperature level.

Sub-cooled recirculation stream 108 is then returned to main cryogenic tank 102 where it is introduced into vapor phase 115 as a spray. When contacted with the sub-cooled liquid, vaporized nitrogen stream 104, returning from liquid nitrogen user 116, is cooled and condenses back to saturated liquid 114.

Cryogenic tank 102 is situated at a higher elevation than that of liquid nitrogen user 116. The elevation of cryogenic tank 102 must be adjusted relatively to the liquid nitrogen user 116 so that the pressure developed by the hydrostatic height of the liquid nitrogen 114 is sufficient to compensate for the pressure drops in the pipes and various instruments such as valves, etc. . . . , so that vaporized nitrogen stream 104, after having passed through liquid nitrogen user 116, has sufficient pressure to vent through 105. The elevation of bottom of 102 tank is determined by static pressure difference to flow through 103B piping 116, 104 and vent valve 105.

In one embodiment, with cryogenic tank 102 sufficiently elevated, vaporized nitrogen stream 104 maybe returned to main cryogenic tank 102, in the absence of a pump within the system. However, in such an arrangement, the required elevation may be excessive and impractical. Thus, the preferred operating method when utilizing only tank elevation and no pump is to vent vaporized nitrogen stream 104 through vent valve 105 with no return to main cryogenic tank 102.

During normal operations, valve 103A will be in the open position, valve 103B will be in the closed position, and vent valve 105 is in the closed position. If an upset condition arises (i.e. a mechanical or power failure to recirculation pump 110) then valve 103A will close, valve 103B will open, and vent valve 105 will open.

The storage height of the main cryogenic storage tank relative to the liquid cryogenic liquid user is to be equal to or greater than a minimum predetermined height. This minimum predetermined height is unique to each installation, and is defined herein as being the vertical distance between the height of the location wherein liquid nitrogen stream 103 exits main cryogenic tank 102 and the height of the lowest point to which this cryogenic fluid is fluidically connected within liquid nitrogen user 116. The minimum predetermined height may be 10 meters, preferably 5 meters, more preferably 1 meter.

The lower the temperature downstream of sub-cooler 106, the lower the required pumped flow into sub-cooler 106 will be. Hence, utilizing the lowest practical downstream temperature will reduce the power consumed by recirculation pump 110, as well as simply reduce the size of recirculation pump 110. However, when approaching such a low sub-cooling temperature, typically below fourteen degree Celsius and preferably ten degree Celsius above the freezing point of nitrogen presents challenges. For example, extreme care must be taken to ensure that there are a very few impurities in the nitrogen stream, especially argon which could freeze and disturb globally the overall process. In order to reach a level of sub-cooling of at least 3 degrees, and preferably 1 degree, above the freezing point of nitrogen, the argon content typically needs to be below 2% mol and preferably below 0.5% mol.

Main cryogenic tank 102 may include first pressure transmitter 119. First pressure transmitter 119 may interface with one or more peripheral interface controller (PIC). First PIC 120 is functionally connected to both first pressure transmitter 119 and recirculation control valve 109. Second PIC 121 is functionally connected to both first pressure transmitter 119 and vent valve 105. Sub-cooler bypass line 118, is fluidically connected to warm recirculation stream 107 and sub-cooled recirculation stream 108, thereby allowing at least a portion of the pressurized recirculation stream exiting recirculation pump 110 to bypass sub-cooler 106. Sub-cooler bypass line 118 may include second pressure transmitter 122. Second pressure transmitter 122 may interface with one or more PICs. Third PIC 123 is functionally connected to both second pressure transmitter 122 and bypass control valve 125. Fourth PIC 124 is functionally connected to both second pressure transmitter 122 and recirculation pump 110.

The delivery pressure of liquid nitrogen stream 103 at the interface with liquid nitrogen user 116 may be linked with the pressure in main cryogenic tank 102. The pressure within main cryogenic tank 102 is primarily controlled by recirculation control valve 109 on the sub-cooled recirculation stream 108 exiting sub-cooler 106. Recirculation control valve 109 opens if the pressure in main cryogenic tank 102 is high and closes if the pressure in the main cryogenic tank 102 is low. The cooling capacity of sub-cooler 106 will adjust depending on the temperature at the outlet. The outlet temperature of sub-cooler 106 is directly impacted by the opening position of recirculation control valve 109 downstream. The greater the amount recirculation control valve 109 is open (meaning main cryogenic tank 102 pressure is high), the greater the temperature downstream sub-cooler 106 will tend to increase. And thus, the cooling capacity of the sub-cooler 106 will be increased. Or, stated another way, the refrigeration provided by sub-cooler 106 will increase or decrease in order to maintain the temperature of sub-cooled recirculation stream 108.

Recirculation pump 110 may be a variable frequency drive (VFD) type pump. The speed of recirculation pump 110 is controlled by a third PIC 123 which will accelerate the pump if the pressure read by second pressure transmitter 122 in the sub-cooling line is low (meaning that the sub-cooling flow is increasing).

If sub-cooler 106 is unable to provide sufficient cooling capacity to compensate for the refrigeration load demanded by liquid nitrogen user 116, the pressure in the cooling loop will increase. In order to prevent the pressure to rise over a desired or predetermined level which could impact liquid nitrogen user 116, vent valve 105 is installed on vaporized nitrogen stream vaporized nitrogen stream 104 returning from the liquid nitrogen user 116 to main cryogenic tank 102. This functions as a secondary pressure controller for main cryogenic tank 102. Vent valve 105 may be installed in between 2 valves (not shown) to be connected to main cryogenic tank 102 only, or to vaporized nitrogen stream 104 only.

The sub-cooling system does not necessarily fully compensate the heat load from the user. It can be of a lower capacity than the heat load by design, it can underperform or be stopped because of a failure or a maintenance, or it can be slowed down on purpose if the trade-off between electrical consumption costs versus the availability of liquid nitrogen becomes interesting.

When the flow in sub-cooled recirculation stream 106 or warm recirculating stream 107 is reduced or stopped, liquid cryogenic fluid stream 103 to liquid cryogenic fluid user 116 is maintained by means of main cryogenic tank 102. The pressure within liquid cryogenic fluid stream 103 and vaporized cryogenic fluid stream 104 will tend to increase due to the cooling load from the user not being compensated by sub-cooler 106. Vent valve 105 will open as required to maintain the desired constant tank pressure.

Liquid buffer Tank 111 is used to isolate the cooling loop (i.e. sub-cooled recirculation stream 106 or warm recirculating stream 107) from perturbations generated by liquid nitrogen transfers from external liquid nitrogen source 117 (such as Trailers loading the loop). The liquid nitrogen inventory in this liquid buffer tank 111 can also be used to maintain the liquid nitrogen supply in sub-cooled recirculation stream 106 and warm recirculating stream 107 when the flow through sub-cooling system is reduced or stopped. The pressure in the liquid buffer tank 111 is controlled by a pressure build-up coil (not shown), while liquid nitrogen is transferred to main cryogenic tank 102.

During start-up of liquid cryogenic fluid user 116, the cooling phase that the equipment must experience may be required to be performed in a controlled way to avoid thermal stress that could damage the equipment. And after shutdown of liquid cryogenic fluid user 116, when the maintenance needs to be done, liquid cryogenic fluid user 116 system also needs to be re-warmed not too fast for the same aforementioned reasons.

A gaseous cryogenic fluid flow 131 is generated at a controlled temperature and supply this nitrogen to liquid cryogenic fluid user 116. Thereby allowing the cooling or warming phase of the equipment located at liquid cryogenic fluid user 116 to be performed with a controlled temperature ramp-down or ramp-up.

Liquid cryogenic fluid 114 is stored at saturated conditions (pressure P1) in main cryogenic tank 102. Liquid cryogenic fluid 114 is extracted from main cryogenic tank 102 and sent to a centrifugal pump. At least a portion of the pumped liquid nitrogen is sent, via valve 103A and line 126 to a vaporization and superheating system 129. The vaporization and superheating may be achieved with any of the following heat exchange medium, but not limited to these, cooling water, ambient air, steam or/and with heat generated by an electrical resistance. The gaseous cryogenic fluid flow 131 thus generated is then sent to the liquid cryogenic fluid user 116. A flow controller 127 controlling flow control valve 128, adjusts cryogenic fluid flow 131 sent to vaporization and superheating system 129. A temperature controller 130 adjusts the gaseous cryogenic fluid stream 131 temperature by regulating the heat input (cooling water flow, electrical power, nitrogen by-pass around the exchanger, etc. . . . ) within vaporization and superheating system 129.

In one embodiment, at the beginning of the cooling phase, the temperature set point can be adjusted to a temperature slightly lower than ambient and when the temperature of the equipment at gaseous cryogenic fluid stream 131 is close to the cryogen temperature coming from the heat load. Then the controller will reduce the temperature progressively to keep the temperature gradient below a maximum value, for example below 1 degC/min. Once the temperature at the gaseous cryogenic fluid stream 131 is low enough, then liquid nitrogen gaseous cryogenic fluid stream 131 can be injected from main cryogenic tank 103. In order to monitor the resulting temperature gradient, thermocouples (not shown) may be added to the specific equipment to be cooled at gaseous cryogenic fluid stream 131.

For the warming phase (before maintenance for example), the procedure would be similar except that the temperature of gaseous cryogenic fluid stream 131 will be cold at the beginning and will progressively warm up to follow the temperature ramp-up.

In another embodiment, at the beginning of the cooling phase, gaseous cryogenic fluid stream 131 is produced at a fixed (cold) temperature. Then the controller will adjust the flowrate to keep the temperature gradient below a maximum value, for example below 1 degC/min. Once the system has cooled down, then liquid nitrogen gaseous cryogenic fluid stream 131 can be injected from main cryogenic tank 103. In order to monitor the resulting temperature gradient, thermocouples (not shown) may be added to the specific equipment to be cooled at gaseous cryogenic fluid stream 131.

For the warming phase (before maintenance for example), gaseous cryogenic fluid stream 131 is produced at a fixed (warm) temperature. This temperature may be close to ambient temperature. Then the controller will adjust the flowrate to keep temperature gradient below a maximum value

Gaseous cryogenic fluid stream 131 used for cooling or warming can be vented through vent valve 105, or can be returned back to main cryogenic tank 102 to be recondensed against sub-cooled recirculation stream 108 from sub-cooler 106 in case cryogenic fluid volume losses are to be limited.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for increasing the reliability and availability of a cryogenic fluid reliquefaction system, comprising:
connecting a reliquefaction system to a liquid cryogenic fluid user which is then supplied a liquid cryogenic fluid,
vaporizing the liquid cryogenic fluid within the liquid cryogenic fluid user, and
venting the vaporized cryogenic fluid,
wherein
the liquid cryogenic fluid is supplied to the cryogenic liquid user in the absence of a pump by elevating the storage height of the main cryogenic storage tank relative to the liquid cryogenic liquid user to a minimum predetermined height,
a sub-cooler with an internal pressure is provided, and
the temperature of the liquid cryogenic fluid downstream of the sub-cooler is at least 1 degree Celsius above the freezing point of the cryogenic fluid at the internal pressure.

2. The method of claim 1, wherein the reliquefaction system comprises at least a main cryogenic tank, a sub-cooler and a recirculation pump.

3. The method of claim 1, wherein the liquid cryogenic fluid is vaporized and/or vaporized and superheated within the liquid cryogenic fluid user.

4. The method of claim 1, wherein the temperature of the liquid cryogenic fluid downstream of the sub-cooler is less than 20 degrees Celsius above the freezing point of the cryogenic fluid at the internal pressure.

5. The method of claim 1, wherein the cryogenic fluid comprises nitrogen.

6. The method of claim 5, wherein high purity liquid cryogenic fluid is used with a predetermined maximum amount of argon to avoid freezing of argon in the sub-cooled part of the reliquefaction loop.

7. The method of claim 6, wherein the predetermined maximum amount of argon is 2% mol.

8. The method of claim 6, wherein the predetermined maximum amount of argon is 0.5% mol.

9. The method of claim 1, wherein the cryogenic fluid is selected from the group consisting of nitrogen, helium, argon, oxygen, krypton, xenon, carbon dioxide, methane, ethane, propane, hydrogen, and combinations thereof.

10. The method of claim 1, wherein the minimum predetermined height is 10 meters.

11. The method of claim 1, wherein the minimum predetermined height is 5 meters.

12. The method of claim 1, wherein the minimum predetermined height is 1 meter.

13. A method for controlling the pressure of a cryogenic fluid reliquefaction system connecting to a liquid cryogenic fluid user which is supplied a liquid cryogenic fluid that is vaporized and sent back to the main cryogenic tank to be recondensed against a sub-cooled liquid stream in a cooling loop, the method comprising:
providing
a main cryogenic tank comprising an internal pressure,
a sub-cooler comprising a recirculation stream flowrate, and
a venting valve,
controlling the internal pressure of the main cryogenic tank by adjusting the recirculation flow to the, and
maintaining the cold supply to the liquid cryogenic fluid user when the sub-cooling line is reduced or stopped by venting the vaporized cryogenic fluid.

14. The method of claim 13, further comprising using a liquid buffer tank for transfers from one or more liquid cryogenic fluid truck trailers to supply the cooling loop using the venting valve, when the recirculation flow is reduced or stopped.

15. The method of claim 13, wherein the reliquefaction system comprises at least a main cryogenic tank, one sub-cooler and a recirculation pump.

16. The method of claim 13, wherein the cryogenic fluid is selected from the group consisting of nitrogen, helium, argon, oxygen, krypton, xenon, carbon dioxide, methane, ethane, propane, hydrogen, and combinations thereof.
